(19) United States
(12) Patent Application Publication
(10) Pub. No.: US 2008/0043785 A1
(43) Pub. Date: Feb. 21, 2008

(54) Single longitudinal mode solid-state laser generated by fiber Bragg grating external cavity

(76) Inventor: Pin Long, Lasalle (CA)

Correspondence Address: MR. PIN LONG, 4321 GARAND, SAINT-LAURENT, QC, H4R 2B4, US

(21) Appl. No.: 11/505,443

(22) Filed: Aug. 17, 2006

(51) Int. Cl. H01S 3/098

(52) U.S. Cl. 372/19

(57) ABSTRACT

Single longitudinal mode solid-state laser comprises solid-state laser and single-mode optical fiber, which Bragg grating is written on, as an external cavity. In one embodiment, the multimode laser is coupled from solid-state laser by lens system into external cavity which includes the optical fiber with Bragg grating written on. In the other embodiment, the multimode laser is coupled from solid-state laser directly into the external cavity which includes lensed optical fiber with Bragg grating written on. The Bragg grating selects lasing wavelength and discriminates against lasing of the other longitudinal modes in the multimode gain region. The solid-state laser with fiber Bragg grating external cavity generates single longitudinal mode laser with narrow spectrum and high side mode suppression ratio. The method is very simple and cost-effective.

### FILED OF THE INVENTION

This invention relates to solid-state laser and fiber Bragg grating. In particular, this invention relates to a single longitudinal mode solid-state laser having a fiber Bragg grating as external cavity.

### BACKGROUND OF THE INVENTION

Single mode laser is a very important device for instrumentation, sensor, biomedical, metrology and telecommunication applications. Solid-state lasers have advantages in compactness and efficiency over other types. To achieve a single traverse mode laser, there are different ways to suppress the high order traverses mode laser.

The U.S. Pat. No. 6,625,182, according to its laser system, a solid medium configured as a transversely multi-mode optical waveguide and the optical feedback from Bragg grating against lasing of higher-order transverse modes to stabilize high power lasing only at the fundamental zero-order transverse mode.

Once lasing is restricted to a single-traverse (TEM₀₀) mode then a single longitudinal mode laser (SLM) becomes an interesting topic.

There is a demand to get narrow linewidth and high side mode suppression ratio of single longitudinal mode laser. Spectral narrowing and mode selection of laser system are becoming critical issues for single longitudinal mode laser. Reducing laser linewidth has been done previously by using a volumetric photothermal refractive Bragg grating cavity mirror.

Te-yuan chung, Alexandra Rapaport et al. used a volumetric photothermal refractive Bragg grating cavity mirror to narrow solid-state laser spectrum. (See Te-yuan Chung, Alexandra Rapaport, Vadim Smirnov, Leonid B. Glebov, Martin C. Richardson, and Michael Bass, Solid-state laser spectral narrowing using a volumetric photothermal refractive Bragg grating cavity mirror, Optics Letters 2006 Vol. 31, No. 2, 229-231). This approach is complicated and costly.

It can be seen that the present invention provides a single longitudinal mode laser, which comprises a solid-state laser and fiber Bragg grating external cavity. The single longitudinal mode laser has narrow linewidth and high side mode suppression ratio to the other longitudinal mode.

### OBJECTS OF THE INVENTION

An object of the present invention is to provide single longitudinal mode laser generated by fiber Bragg grating external cavity that obviates the other multiple longitudinal mode laser coming from solid-state laser.

Another object of the present invention is to provide single longitudinal mode laser generated by fiber Bragg grating external cavity with a simple method.

A further object of the present invention is to provide single longitudinal mode laser generated by fiber Bragg grating external cavity, which has narrow linewidth and high side mode suppression ratio.

Still another object of the present invention is to provide a low cost single longitudinal mode laser generated by fiber Bragg grating external cavity.

Other objects and advantages of the present invention will become apparent from a careful reading of the detailed description provided herein, with appropriate reference to the accompanying drawings.

### SUMMARY OF THE INVENTION

According to the present invention, there is provided single longitudinal mode solid-state laser generated by a solid-state laser with fiber Bragg grating external cavity for getting a narrow linewidth and high side mode suppression ratio. Single longitudinal mode solid-state laser comprises a solid-state laser with or without AR coating, a lens system and a single-mode optical fiber Bragg grating acting as an external cavity. The lens system can be replaced by using a lensed single-mode optical fiber instead of a normal single-mode optical fiber. Bragg grating on single-mode optical fiber selects single longitudinal mode laser and suppress the other longitudinal mode lasers. The feedback given to the solid-state laser by the fiber Bragg grating becomes a selective factor that enables us to obtain a single longitudinal mode laser. The period on the Bragg grating is corresponding to the desired single longitudinal mode wavelength. The reflectivity of the fiber Bragg grating and the laser driving current are important factors in the side mode suppression.

Preferably, solid-state laser may be a diode pumped solid-state laser.

Preferably, power of laser driver is in the range of diode-pumped solid-state laser requirement.

Normally, the side mode suppression ratio depends on the laser driving current value.

Preferably, the laser system further comprises solid-state laser with AR coating or without AR coating.

Preferably, the lens system or the lensed single-mode optical fiber couples the light coming from solid-state laser.

In yet a further set of embodiments, the laser system further comprises the different solid-state laser or different types of laser.

Preferably, the lens system comprises one or multiple lenses.

Preferably, the lens system can be replaced by lensed optical fiber.

Preferably, in one embodiment, one side of single-mode optical fiber with Bragg grating is near written on, couple the light from lens system.

Preferably, in another embodiment, one side of lensed single-mode optical fiber with Bragg grating written on, couple the light directly from solid-state laser.

Preferably, the laser system further comprises the fiber Bragg grating with different periods, different reflectivity and different full width half maximum bandwidth.

Preferably, the other side of the single mode optical fiber connects to the output side, which can be measured by measurement instrument such as optical spectrum analyzer.

### BRIEF DESCRIPTION OF THE DRAWINGS

In the annexed drawings, like reference characters indicate like elements throughout.

FIG. 1 is a view of an embodiment setup using diode-pumped solid-state laser, lens system and fiber Bragg grating to generate single longitudinal mode laser, showing the fiber Bragg grating select a single longitudinal mode laser from multiple longitudinal mode lasers coming from diode-pumped solid-state laser.

FIG. 2 is a view of an embodiment of setup using diode-pumped solid-state laser, a lensed single-mode optical fiber with Bragg grating to generate single longitudinal mode laser, showing the fiber Bragg grating select a single longitudinal mode laser from diode-pumped solid-state laser.

FIG. 3 is a view of an embodiment of setup using diode-pumped solid-state laser, a lens system, and single-mode optical fiber without fiber Bragg grating, which generates multiple longitudinal mode lasers.

FIG. 4 is a view of an embodiment of setup using diode-pumped solid-state laser, a lensed single-mode optical fiber without Bragg grating to generate multiple longitudinal mode lasers.

FIG. 5 is spectrum of the fiber Bragg grating, which is used in FIG. 1 by generating single longitudinal mode laser together with diode-pumped solid-state laser. The spectrum of the fiber Bragg grating is measured by an optical spectrum analyzer.

FIG. 6 is spectrum of single longitudinal mode laser, which is generated by diode-pumped solid-state laser, a lens system and single mode optical fiber with Bragg grating written on as an external cavity as FIG. 1 setup system.

FIG. 7 is spectrum of multiple longitudinal mode lasers, which are generated directly by diode-pumped solid-state laser, a lens system and single mode optical fiber without Bragg grating as FIG. 3 setup system.

### DETAILED DESCRIPTION OF THE PREFERRED EMBODIMENTS

With reference to the annexed drawings the preferred embodiment of the present invention will be herein described for indicative purpose and by no means as of limitation.

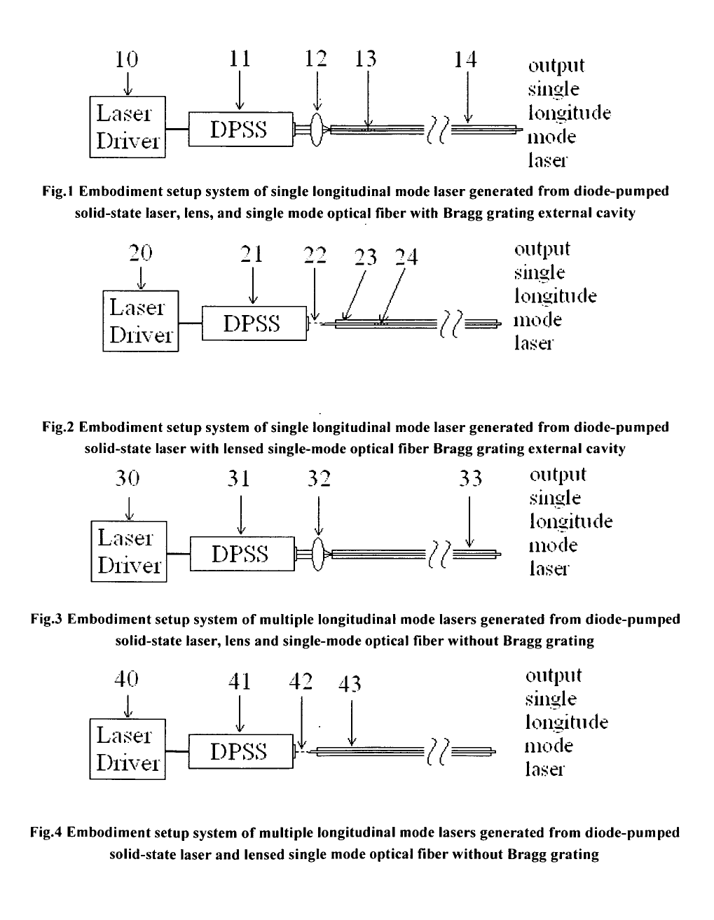

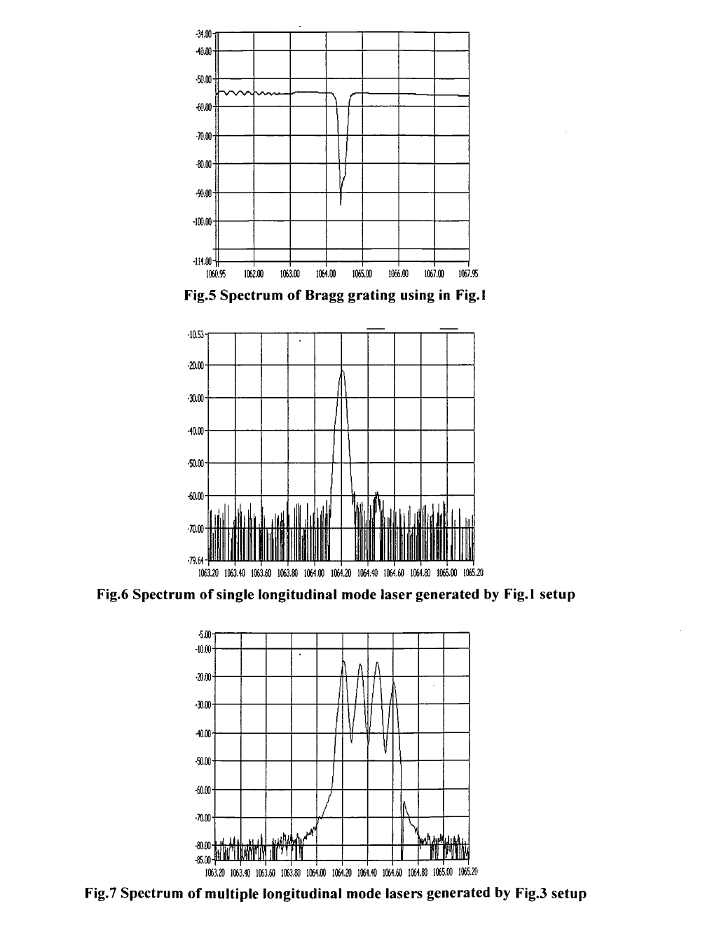

Referring to FIG. 1, there is shown an embodiment of a single longitudinal mode laser which comprises 10 of a laser driver, 11 of a diode-pumped solid-state (DPSS) laser, 12 of a lens system, 13 of Bragg grating which is written on 14 of single mode optical fiber. The other side of 14 of single-mode optical fiber is the output of single longitudinal mode laser. It can be measured by measuring instruments such as an optical spectrum analyzer.

13 of Bragg grating written on 14 of single mode optical fiber can be used as a wavelength and mode selector of laser. The central wavelength selected by 13 of Bragg grating is insensitive to temperature.

According to the invention, 13 of Bragg grating is written on the input side of 14 of single mode optical fiber. The size and location and possible multiplicity of 13 of Bragg gratings on 14 of single mode optical fiber are not limited.

12 of a lens system is used as focusing the light from 11 of diode-pumped solid-state laser into the side of 14 of single mode optical fiber which is near 13 of Bragg grating. One or multiple simple lenses can be used. The function of the lens system is to reduce the size of the light beam, which is coming from 11 of diode-pumped solid-state to the input side of 14 of single mode optical fiber which is near 13 of Bragg grating.

The diameter of its circular core of 14 of single mode optical fiber is on the order of 4 to 6. mu.m in this embodiment. Further, the other types of fiber structure are possible to use.

Referring to FIG. 2, there is shown an embodiment of a single longitudinal mode laser which comprises 20 of a laser driver, 21 of diode-pumped solid-state (DPSS) laser, 22 light come from DPSS laser coupled to the side of 23 of lensed single mode optical fiber which 24 of Bragg grating is written on, the other side of 23 is the output single longitudinal mode laser. It can be measured by measuring instruments such as an optical spectrum analyzer.

24 of Bragg grating written on 23 of single mode optical lensed fiber can be used as a wavelength and mode selector of laser. The central wavelength of single longitudinal mode selected by 24 of Bragg grating is insensitive to temperature.

According to the invention, the function of 23 of single mode optical lensed fiber can couple more light than normal single mode optical fiber just like a lens system. But 23 of single mode optical lensed fiber enable the device miniaturization, alignment simplification and cost reduction. This lensed fiber is either laser shaped lensed fiber or polished lensed fiber.

24 of Bragg grating is written on the input side of 23 of lensed single mode optical fiber. The size and location and possible multiplicity of 24 of Bragg gratings on 23 of single mode optical fiber are not limited.

|Referring to FIG. 3 and FIG. 4 are corresponding to FIG. 1 and FIG. 2. The difference between them is without or with Bragg grating written on the single mode optical fiber or lensed single mode optical fiber.

In FIG. 3, 30 of a laser driver, 31 of diode-pumped solid-state laser and 32 of a lens system are the same as 10 of a laser driver, 11 of diode-pumped solid-state laser and 12 of a lens system in FIG. 1. In FIG. 3, there is no Bragg grating written on 33 of a single mode optical fiber. 33 of single mode optical fiber is corresponding to 14 in FIG. 1. Without Bragg grating, multiple mode lasers from the output side of 33 of single mode fiber can be measured by measuring instruments.

In FIG. 4, 40 of a laser driver, 41 of diode-pumped solid-state laser, 42 of light comes from diode-pumped solid-state laser coupled into 43 of lensed single mode optical fiber. 43 of lensed single-mode optical fiber can be laser shaped lensed fiber or polished lensed fiber. Without Bragg grating, the spectrum of multiple mode lasers from the output side of 43 of lensed single-mode optical fiber can be measured by measuring instruments such as an optical spectrum analyzer.

Referring in FIG. 5, optical spectrum analyzer measures reflectivity spectrum of the Bragg grating, which is written on single mode optical fiber as an embodiment of FIG. 1. The reflectivity of Bragg grating is 99.9%. The full width half maximum (FWHM) bandwidth is 0.4 nm and the central wavelength is 1064.22 nm.

Referring in FIG. 6, there is an embodiment of a single longitudinal mode laser generated by setup system as shown in FIG. 1 and fiber Bragg grating having spectrum as shown in FIG. 5. Bragg grating written on the single mode optical fiber is used as a selector of central wavelength. Bragg grating is also used to suppress the other longitudinal mode lasers. The side mode suppression ratio is also relative to the laser driving current value. The spectrum of single longitudinal mode laser is measured by optical spectrum analyzer from the output side of single mode optical fiber.

Referring in FIG. 7, there is an embodiment of multiple mode laser generated from diode-pumped solid-state laser without fiber Bragg grating setup system as shown in FIG. 3. The single-mode optical fiber cannot be a selector to obtain single longitudinal mode laser without Bragg grating. The spectrum of multiple longitudinal mode lasers is measured by an optical spectrum analyzer from the output side of single mode optical fiber.

I claim:

1. A single longitudinal mode laser device comprising: a solid-state laser, a lens system having the function of coupling and focusing more light to a single mode optical fiber, and said single mode optical fiber has a small core diameter to not support high order mode laser, and a Bragg grating written on said single mode optical fiber selecting a predetermined central wavelength of laser and suppressing the other longitudinal mode lasers.

2. A single longitudinal mode laser device as defined in claim 1, wherein said a lens system can be either simple one or multiple lens.

3. A single longitudinal mode laser device as defined in claim 1, wherein said solid-state laser is operated with multiple wavelength of operation that includes 1064 nm.

4. A single longitudinal mode laser device as defined in claim 1, wherein said solid-state laser can be with or without AR coating.

5. A single longitudinal mode laser device as defined in claim 1, wherein said solid-state laser can be diode-pumped or other types of solid-state laser, and it might be the other types of laser.

6. A single longitudinal mode laser device as defined in claim 1, wherein output of said solid-state laser is coupled to a fiber gain medium by said lens system.

7. A single longitudinal mode laser device as defined in claim 1, wherein said Bragg grating has a reflection bandwidth within the gain spectrum of said solid-state laser.

8. A single longitudinal mode laser device as defined in claim 1, wherein said Bragg grating can be one or multiple gratings with different periods and reflectivity at least 90% and said solid-state laser is without AR coating.

9. A single longitudinal mode laser device as defined in claim 1, wherein said Bragg grating can be one or multiple gratings with different periods and lower reflectivity and said solid-state laser is with AR coating.

10. A single longitudinal mode laser device comprising: a solid-state laser, a lensed single-mode optical fiber which can be coupled more light from said solid-state laser, and said lensed single mode optical fiber has a small core diameter which can not support high order traverse mode laser, and a Bragg grating written on said lensed single mode optical fiber selecting a predetermined central wavelength of laser and suppressing the other longitudinal mode laser.

11. A single longitudinal mode laser device as defined in claim 5, wherein said lensed single-mode optical fiber can be either laser shaped lensed fiber or polished lensed fiber.

12. A single longitudinal mode laser device as defined in claim 5, wherein said solid-state laser is operated with multiple wavelength of operation that includes 1064 nm.

13. A single longitudinal mode laser device as defined in claim 5, wherein said solid-state laser can be with or without AR coating.

14. A single longitudinal mode laser device as defined in claim 5, wherein said solid-state laser can be diode-pumped or other types of solid-state laser, and it might be the other types of laser.

15. A single longitudinal mode laser device as defined in claim 5, wherein the output side of said solid-state laser is coupled to a lensed fiber gain medium.

16. A single longitudinal mode laser device as defined in claim 5, wherein said Bragg grating has a reflection bandwidth within the gain spectrum of said solid-state laser.

17. A single longitudinal mode laser device as defined in claim 5, wherein said Bragg grating can be one or multiple gratings with different periods and reflectivity at least 90% and said sold-state laser is without AR coating.

18. A single longitudinal mode laser device as defined in claim 5, wherein said Bragg grating can be one or multiple Bragg gratings with different periods and lower reflectivity and said solid-state laser is with AR coating.
